(19) United States
(12) Patent Application Publication
(10) Pub. No.: US 2002/0152128 A1
(43) Pub. Date: Oct. 17, 2002

(54) System and method for delivery of remotely ordered items

(76) Inventors: Charles Walch, St. Louis, MO (US); Carter Williams, Ladue, MO (US)

Correspondence Address: THOMPSON COBURN, LLP, ONE FIRSTAR PLAZA, SUITE 3500, ST LOUIS, MO, 63101, US

(21) Appl. No.: 09/835,158

(22) Filed: Apr. 13, 2001

(51) Int. Cl. G06F 17/60

(52) U.S. Cl. 705/26

(57) ABSTRACT

A system and method of delivering remotely ordered consumer items including recording a current purchase order of the consumer; scanning a unique product code for entering onto the current purchase order data identifying at least one item; selecting at least one item for the current purchase order from an Internet web page; aggregating one or more items on the current purchase order from at least one merchandiser within a local area; bundling the aggregation of items with at least one item received from beyond the local area; and/or retaining the items at an errand center storefront for retrieval by the consumer or any combination thereof.

### CROSS REFERENCES TO RELATED APPLICATIONS

None

### STATEMENT REGARDING FEDERALLY SPONSORED RESEARCH OR DEVELOPMENT

Not Applicable

### FIELD OF USE

The present invention is a method of consumer goods ordering, shipping, and delivery through the use of a horizontal system centered around a network of neighborhood errand centers storefront delivery depots for consumers and merchants to utilize as both a storefront and delivery depot. The present invention improves the efficiency of current ordering, transporting and delivery channels for consumer goods and services and facilitates logistic completion of consumer e-commerce transactions made over the Internet. The present invention is in the field of “last mile” solutions.

### BACKGROUND

Traditional logistics for deliveries to individuals, particularly the delivery of consumer goods to consumer's homes, include inherent inefficiencies. Twenty-five percent of all residential deliveries in 1999, that is, 250,000 attempted deliveries, failed on a first attempt because the recipient was not home. A larger number of shipments were left unattended on a consumer's doorstep, making them vulnerable to theft or loss, “Deliveries Try to Keep Up With Online Shopping,” Rachel Beck, Associated Press, May 31, 2000.

Shipping inefficiencies and costs become more critically important in the area of electronic commerce and on-line shopping over the Internet. Shipping costs constitute 11% of an e-commerce consumer order, averaging $6.95 per order, “Few Categories of Retail E-Commerce are Profitable,” The Industry Standard, Jun. 20, 2000. Eighty-two percent of consumers consider shipping costs critical when making their buying decision, “The Double Edge Sword of Free Shipping,” Chet Dembeck, E-Commerce Times, Jan. 14, 2000. As e-commerce expands as an alternative to traditional channels of commerce, particularly consumer retail commerce, greater efficiencies are needed, both for their own sake and for the reduction in shipping costs that efficiency will generate. Greater efficiency is valuable both for e-commerce as it is practiced at current levels, and will become proportionally more important as e-commerce penetrates farther into commerce and shipping markets as currently practiced in the United States.

Parcel delivery systems, such as practiced currently in the art by United Parcel Service, Federal Express and the United States Postal Service, are most often efficient, inexpensive on a per unit cost basis and profitable when shipment density is high. Because each parcel represents a single revenue unit, picking up a large volume of units from a seller's warehouse and delivering them all to a single recipient is what usually makes the system efficient, profitable, and cost effective on a per unit basis. Accordingly, “batching” computer systems have been developed previously to economize conglomerating packages destined for the same routes and terminal stations. See, U.S. Pat. Nos. 5,051,914; 5,068,797 and 5,072,401.

Conversely, a separate delivery, as to an individual consumer's residence, for each package is cost ineffective per revenue unit, unprofitable, inefficient and leads to high per package shipping costs. Scheduling and routing systems have been developed to seek efficiencies in this area as well. See, U.S. Pat. Nos. 5,450,317; 5,631,827; 6,003,010; and 6,029,140.

Efficiencies have also been sought by using a single depot for storing the stock of multiple local vendors. See, U.S. Pat. No. 5,158,155. Such systems warehouse general stock, however, and do not retain items already selected by a consumer.

The expansion of e-commerce ordering, and residential shipping appurtenant thereto, exacerbates conflicting needs in the marketplace. Increased volumes of individual revenue unit deliveries to individual residences will put pressure on shippers to increase per unit shipping costs. Simultaneously, e-commerce retailers will be under increasing pressure to reduce per unit shipping charges. A method is needed to maintain shipper's profitability while reducing per unit delivery costs. This problem is a part of what is known colloquially as the “last mile problem.”

Capacity is also an issue. The number of shipments sent to consumers residences is projected to double by 2003 to 6.3 million per day, “Mastering Commerce Logistics”, Forrester Research, Stacie S. McCullough, August 1999. Some surveys indicate that as much as one-quarter of household expenditures could be made on-line, which correlates to an annual on-line expenditure of between $10,000 and $15,000 per year, in Internet accessible households, V. Padmanabhan (1999) and Bureau of Labor Statistics (2000).

From the consumer's perspective, time efficiencies can potentially be gained by shopping online by either eliminating or consolidating errands. Such local pick up items such as dry-cleaning and groceries currently require trips to several different errand center storefronts. With the Internet's ability to allow a consumer to order a bundle of goods in advance over the Intranet, local errands like grocery shopping can be delivered to the home as well. Or, if not delivered to the home, a one stop location for picking up all such local items and/or items shipped via parcel delivery, such as does not exist in the current state of the art, would save the consumer valuable errand time by consolidating several errand stops into one.

Various delivery systems incorporating e-commerce orders are known in the art. On line ordering from multiple, local only vendors for delivery of items to the consumers home is disclosed in U.S. Pat. No. 5,991,739. Delivery management systems sharing data between seller, buyer and deliverer are also known. See, U.S. Pat. No. 6,085,170. However, none of them are addressed to optimizing consumer convenience in a way that is universal among all the consumer's errands, while simultaneously reducing shipping costs and inefficiencies. “Vertical” systems such as “Webvan” or “Kozmo” promote consumer convenience, but only convenience for the delivery of one retailer's products. These solutions also do not solve the per unit inefficiency and cost problems outlined above for the parcel systems and merchants who ship through such systems. Other systems such as “Parachute” and “DeliverEnow” offer consumer convenience with same day delivery of local delivery, but charge a premium for it. They too do not assist merchants who ship via parcel systems. The prior art further includes drop off solutions, such as at a store front, for example “MailBoxes Etc.,” or “PaxZone” which arrange shipment drop off at a cooperating neighborhood store front, or “Mental Physics,” which installs lock boxes at the consumer's house. However these solutions only help merchants who ship through parcel systems; they do not help merchants who wish to fulfill Internet orders from consumers out of local stores. Also there is often a charge for these services. This charge counteracts the shipping cost reduction of shipping the parcel to a neighborhood delivery depot, which increases per unit efficiencies and solves the problem of delivering to residences when the consumer is not at home. Furthermore, these systems do not afford the convenience of errand consolidation with regard to items ordered from local retailers. Drop box systems have also been patented. See, U.S. Pat. No. 4,894,717 to Komei and U.S. Pat. No. 4,774,052 to Porter.

There is a need for a method and system that reduces cost, increases efficiency and consumer convenience, and facilitates electronic commerce.

### SUMMARY OF THE INVENTION

It is an object of this invention to aggregate consumer purchase selections into a bundle for delivery, and that such aggregation should include multiple items selected for purchase from more than one retailer or merchant multiple items from one merchant or a single item. In a preferred embodiment, such an aggregation is achieved by a local courier retrieving from at least one local merchant the items selected for purchase by the consumer. In a most preferred system, that courier is an agent of this system of the present invention.

It is a further object of this invention that aggregation of purchase items for a consumer bundle may include consumer items received from long-distance shippers. In a preferred embodiment such items from beyond the range of the local courier may be bundled with locally aggregated items at a local area depot. It is a further object of this inventive system that such non-local items be ordered by the consumer over a distributed communication network, such as the Internet.

It is a further object of this invention that non-local items received from long distance shippers, whether bundled with local items or not, be delivered by the long distance shipper to the local depot, and not the consumer's home. In this fashion economies of scale are achieved in that a single long distance delivery can be made of multiple items for delivery to consumers within the depot's local geographical area.

In a preferred embodiment, a depot's local area may be defined geographically. In alternative embodiments local areas may be defined by population, retailer concentration, routing traffic, or other parameters which may prove efficient.

It is a further object of this inventive system that consumer selected items from one or more local merchants, one or more remote merchants, either or both, are delivered to the local delivery depot and afterwards they may be rerouted and delivered to the consumer's home. Home delivery may be at a pre-determined time selected by the consumer from among a set of times made available to the consumer by the system. In a preferred embodiment such times are made available and selected over a distributed communication network such as the Internet. In a most preferred embodiment such scheduling is made through a merchant's site on the distributed network, such as the Internet, whether the merchant is local or otherwise. Preferably, achievement of this scheduling may be through an Application Programming Interface (“API”), the apparatus and method of which is a further object of this invention.

It is a further object of this invention that after such consumer selected items are delivered to the local depot, they may be alternatively held there for pick up by the ordering consumer at a public store front of the depot, called the errand center storefront. The consumer may elect whether item delivered to the home or retained at the errand center storefront.

In a preferred embodiment, the errand center storefront is itself a retail outlet for multiple consumer goods and services, including, by example and not by way of limitation, dry cleaning, coffee, packaging services, small item repairs (shoes, watches), or ready to eat meals. In this fashion, a consumer's non-preferred errands may be incorporated with the consumer's preferred errands. Such a combination of consumer convenience and preferences would support some service charge should the consumer elect to have their “errand bundle” retained for pickup at the errand center storefront, or rerouted to the home at a predetermined delivery time.

It is a further object of the present invention that the various aspects, embodiments, objects, including but not limited to the errand center storefront, delivery time, local aggregation, long distance shipment receiving, long distance/local bundling, and API be modular; that is, any single independent aspect, or combination of them, may be added to existing distribution, merchandising, retailing or other systems, by any consumer, any local retailer, any catalog merchandiser, or any e-commerce merchandiser, and have such addition(s) augment the economy, efficiency and profitability of the systems to which such elements are added. By way of example, and not limitation, a local retailer may agree to participate to have consumer selected items from a manual shopping list picked up by a local courier for a customer. At a later time the same local retailer may chose to establish a web site whereby the same consumers shopping list could be received over the Internet. At a still later time the same local merchant may chose to incorporate the API of the present system into his web site in order to automate notification of the system's courier that a consumer has selected items from that local retailer's web page for delivery. As a horizontal, scaleable incorporation of any number of merchandisers, the system of the present invention would not compete directly with any of the merchandisers individually. Moreover, no particular brand would be preferred by application of any element of the present system, and accordingly consumer brand loyalty could be maintained. The modularity of the system could allow for retailers, or consumers, or shippers to add the aspects of the current inventive system in stages.

It is a further object of the present invention that ordering, routing, shipping, delivery time selection, delivery preference selection and the like be preferably actuated over the Internet, although alternative distributed networks, e.g., the telephone system, are within the scope of the present invention.

It is a further object of the present invention that the system make available to merchandisers of all types an Application Programming Interface whereby through addition of such an executable program to its web page the merchandiser can effect delivery according to the various other aspects of this inventive system, or aspects of traditional systems, or a combination thereof. In a preferred embodiment, the API of the present system “data mines” consumer preferences for further marketing study, promotional purposes or achievement of efficiencies.

It is a further object of this invention that a data structure be maintained embodying a list of consumer preferences for each customer of this system wherein items bought, how often the customer may need them, preferred brands, volumes, models, versions, vendors etc. are stored. Such list keeping memories are known. See, U.S. Pat. Nos. 5,483,472 and 5,884,281, reciting memory data arrays which are not integrated into any delivery system. Similar memories accommodating third party input are also known for gift registries. See, U.S. Pat. Nos. 5,754,981; 5,774,874; and 5,970,474. In a preferred embodiment of the present invention the list is organized by local and long distance merchandisers with product preferences as a sub-category.

In another preferred embodiment a subsidiary data structure records expected dates when replacements for fungible items will be needed, and either send reminders to merchants, consumers, the errand center storefront, or any combination thereof, or automatically place such items on the consumer's current purchase order. In another preferred embodiment consumers themselves approve of a “subscription” whereby routinely exhaustible items, such as milk or cereal, are automatically put on the consumers current purchase order and delivered on a preestablished periodic basis, such as once a week.

It is a further object of the present invention that item may be recorded onto the consumers current purchase order by scanning the items' unique product code for data identifying the item. It is a further object of the present invention that the data structure comprising the preferences list described above may have items entered into it by scanning a unique product code. Such scanned shopping systems with memories are known. See, U.S. Pat. Nos. 5,424,524; 6,101,483; and 6,123,259. These prior art systems are not integrated with on line ordering, delivery systems or other aspects of the present invention. It is a further object of the present invention that certain items from the memory data structure, preferred or otherwise, may be selected from that list for a current order and that this selection may be also made by scanning a unique product code.

It is a further object of the present invention that drop off delivery for later consumer pick up may be had at a kiosk located at the premises of a public, local retailer who agrees to host the kiosk with the system. In this way the geographical convenience of the errand center storefront concept is multiplied by the presence of a plurality of kiosks, each serving a smaller group in a more localized area. In a preferred embodiment the kiosk is franchised to retailers desiring increased walk-in consumer traffic from the presence of the kiosk.

It is a further object of the present invention that the errand center storefront efficiency and convenience may be increased with a proximity alarm to initiate bundling of individual consumer items from the storage depot if necessary, and bringing the bundle from the depot to the errand center storefront for customer pickup. It is anticipated that the depot and errand center storefront are in the same building. The proximity alarm would be actuated by known technology.

Further features and advantages of the present invention, as well as the structure and operation of various embodiments of the present invention, are described in detail below with reference to the accompanying drawings.

### BRIEF DESCRIPTION OF THE DRAWINGS

FIG. 1 is a flow chart of the distribution system of the present invention.

FIG. 2 is a block diagram of the data transfer path of the present invention.

FIG. 3 is a block diagram of the scanning features of the present invention.

### DETAILED DESCRIPTION OF THE INVENTION

The present invention is a system for increasing the efficiency of logistics for several aspects of current consumer goods shopping, shipping and delivery systems, particularly as they are applied to consumer use of Internet services and E-commerce shopping. In short, the system and method of the current invention solves the “last mile” problem.

The system and method of the present invention is modular. Each aspect of the system may stand alone to increase economies, conveniences or efficiencies. The present system offers an array of combinations of its various aspects. Each combination has a symbiotic effect on its constituent aspects. Consumers, retailers and e-commerce merchants and shippers may participate in various combinations of offered services as they choose.

The first aspect of the present system is the errand center storefront. The errand center storefront is a consumer goods delivery depot combined with a retail errand center storefront. Errand center storefronts serve a geographic area defined in terms of population, surface area, retailer concentration, routing efficiency or any other useful parameter. By providing a simple drop off site for all of a long-distance shippers' deliveries for the entire population within the errand center storefront area, economies to scale are gained and single residence delivery inefficiencies are avoided. The inefficiencies avoided by the present system include multiple drop offs of single revenue unit, delivery recipients who are not at home and residential streets which require more time to navigate between stops. By avoiding these inefficiencies costs are reduced.

The errand center storefront will have storage capacity to hold goods until consumers pick them up or they are rerouted to the consumer's home for delivery. This will be done in a warehouse space in close proximity to the errand center storefront It will be staffed by consumer service clerks. The errand center storefront will have capacity to cache perishable items. Curb service can be available. A customer proximity alarm unique to individual consumers who chose to carry them may be used to speed retrieval of warehoused items by giving clerks advance notice of a consumer's approach. Such alarms work according to known technologies used, for example, in parking garages. Errand center storefronts may be located along major commuter routes for easy access.

The errand center storefront will also be a retail storefront itself where services such as dry cleaning, watch or shoe repair, one time use items such as ready to eat meals or coffee, or packaging services for return purchases or other parcel shipping needs are all offered. Services such as coffee or meals are generally “preferred” consumer errands, i.e., enjoyable errands. It is contemplated that the system of the present invention will combine non-preferred errands together with preferred errands in a single stop for the consumer. This combination is both appealing and efficient. The errand center storefront may also serve as a community or social locus.

The errand center storefront is also a dispatch center for the local delivery service contemplated by the present invention. Courier services, at premium prices, are known. Also known are “vertical” delivery systems, wherein a merchandiser will offer home delivery of its goods. Such delivery systems as “WebVan,” “Kozmo” or “Peapod” offer delivery of goods sold only by one merchant. Conversely, couriers dispatched according to the present invention will gather a horizontal consumer market basket. That is, couriers will travel to the stores of any number of merchants within the local errand center storefront area and gather together, or aggregate, the particular items ordered by a consumer. It is contemplated that the present system may be embodied by participating retailers' stock boys gathering consumer order items and taking the aggregated items to the errand center storefront, or turning them over to a courier. In the preferred embodiment the courier is an agent of the system of the present invention.

The shipping costs of such local errand running service is drastically cut by the use of the system of the present invention due to factors of shipment density and route efficiency. An aggregated local market bundle, when routed to a neighborhood delivery depot such as an errand center storefront, affords the local merchant the opportunity to consolidate all the shopping trips placed via the Internet for the merchant's neighborhood store into one daily trip by the courier. The courier can then make trips to other merchants in the neighborhood and pick up their aggregate bundles on the same route. The costs of the courier route are thus shared across many local merchants aggregating orders for many local consumers, thereby driving down the shipping costs for the consumer. The aggregated local market bundles are then resorted at the local errand center storefront into errand bundles for individual consumers, who may elect to pick up the bundle at the errand center storefront or have it sent directly to the home.

These efficiencies are particularly well suited for combination with the Internet. Long-distance consumer purchasing of goods through distributed telephone networks from catalogs is known. Long distance consumer purchasing of goods through the distributed e-commerce computer network, the Internet, is also known. Sorting and rerouting deliveries across various routes and through a centralized sorting hub is also known. The system and method of the present invention, which reduces shipping costs for merchants using local or long-distance shipping systems by aggregating multiple local and/or long-distance purchases into a single errand bundle and staging said errand bundle at a consumer-accessible delivery depot/retail errand center storefront, is not known. Since shipping costs are critical to profit margins for e-commerce merchandisers and are important to consumer decisions about buying over the Internet, the system and method of the present invention can facilitate e-commerce transactions for merchants and consumers to a degree not previously known in the arts.

The present invention combines both and local and long distance delivery systems into one. Long distance shipped items, primarily from e-commerce merchandisers but also from catalog merchants and private individuals, are aggregated by the local courier into the collection of local market basket items for the ordering consumer.

Further efficiency is achieved when services requiring item transfer, i.e., dry cleaning, shoe or watch repair, and the like are added to the aggregation, either for errand center storefront consumer pick up or home delivery.

From the consumer's perspective, a fourth major time saving efficiency occurs when the consumer may combine pick up of the aggregated market basket, a non-preferred chore, with the preferred errands such as pick up of morning coffee or ready to eat meals. The combined system of the present invention thereby simultaneously increases consumer convenience, for which the consumer is willing to offer some payment, while decreasing the marginal cost of delivering all services and goods.

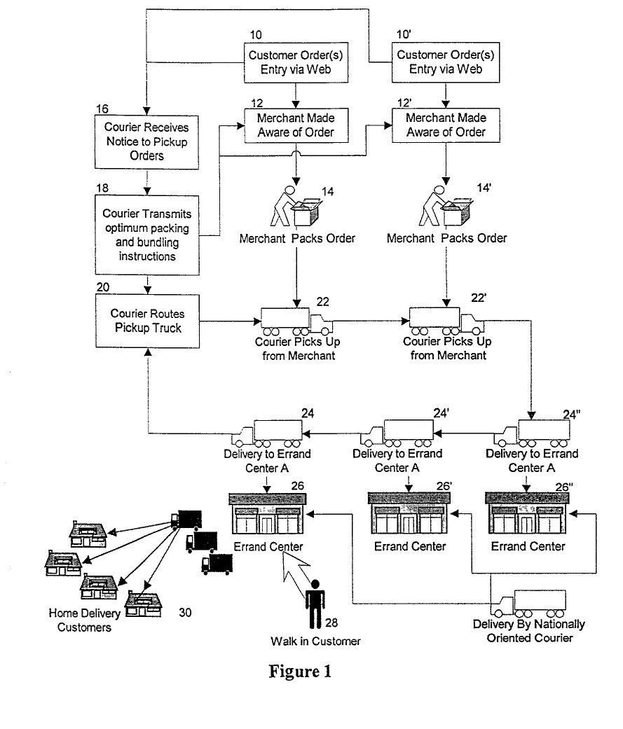

FIG. 1 is a flow chart of the delivery logistics system of the present invention in operation. The steps depicted in FIG. 1 are according to a preferred embodiment. Those of skill in the art will understand that there may be equivalents. Step 1 is the customer's original order entry, 10. The fact that the delivery logistics system of the present invention is horizontal, that is, the present system accommodates a consumer's current purchase order of items from a plurality of merchants, is depicted in FIG. 1 by the reproduction of certain parallel steps by the plurality of merchants depicted as 10′ for the first step. The consumer current purchase order is transmitted by a distributed telecommunications network, preferably the Internet, to the merchant, 12, and 12′, and the courier, 16.

In a preferred embodiment, the courier central system processor in combination with the central system memory, is capable of optimizing, batching and routing of a plurality of consumer purchase orders. This optimization step may be according to systems known in the art, See U.S. Pat. Nos. 5,061,914; 5,068,797; 5,072,401; 5,450,317; 5,631,827; 6,003,010; and 6,029,140, the entire disclosure of which are hereby incorporated by reference, or may be by other means. It may be preferred that such routing and batching conclusions may be translated into individual merchant instructions for which consumer purchase orders should be bundled together, primarily according to their destination errand center area. This data is then transmitted to the merchant, 18. Thereafter the merchant packs the orders, 14 and 14′.

In a preferred embodiment, the present delivery logistic system's computer processor generates optimal courier pick up routes, 20. Thereafter, and according to the optimal routes, couriers pick up purchase order packages from the merchants, 22, and 22′. Pickups may be made by a single courier or a plurality of couriers according to volume, demand and efficiencies. In the representation of FIG. 1, local couriers picking up from merchants within the geographic area corresponding to an errand center, or picking up within the area of a nearby errand center but within the same metropolitan area, are considered to be an aggregating step. Aggregation is completed when the courier delivers packages containing current purchase orders to appropriate designated errand centers, as in step 24, 24′ and 24″. Aggregation is completed at the errand centers when consumer purchase orders are stored together or delivered together to the consumer, although they may have arrived at the errand center at step 24 by a plurality of couriers. This errand center activity in storing, steps 26, 26′ and 26″, also incorporate bundling of current purchase order items from local merchants with items received at the errand center that have been shipped to the errand center from out of the local area and out of the relevant metropolitan area by any commercial shipper such as the U.S. Postal Service, Federal Express or United Parcel Service.

The final step of consumer receipt of his or her purchase order may be by the consumer going to the errand center to pick up the order, 28, or by home delivery, 30. The system of the present invention may be incorporated with already known routing efficiency systems and already known systems whereby a consumer designates delivery addresses and times. Prior art systems are vertical, in that only a single merchant is capable of pre-arranging delivery time over known Internet services. Horizontal courier services, for example, “Parachute,” are currently known to incorporate Internet ordering or Internet designation of delivery time. It will be understood by those in the art that the system of the present invention may incorporate consumer receipt of a current purchase order by walk-in, or in combination with home delivery at a designated time by Internet designation with the capability of delivering items from a plurality of merchants.

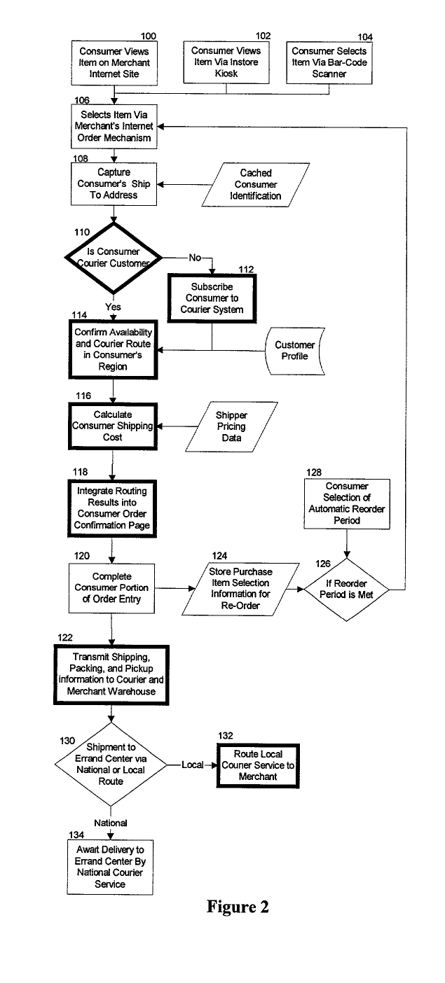

FIG. 2 is a more detailed depiction of data transfer according to the method and apparatus of the present system. A consumer may select items for inclusion in the consumer's current purchase order by a variety of modalities. The consumer may view a merchant's web site from any desktop or hand held Internet access device, 100. A consumer may also view purchase order selection options at a retail outlet display terminal as, for example, at a kiosk, 102. It will be appreciated by those of skill in the art that while selection is a presumed antecedent to the first step of the present system, any means of making the consumer aware of potential selections is contemplated to be within the scope of use of the present system. Thus, the consumer may view selections on the Internet, in an advertising circular, in a catalog, on broadcast media, such as radio or television, or the consumer may simply remember desired items. In any case the consumer's selections are communicated to the system of the present invention. This communication of selections may also be by any of a variety of means, such as a telephone call to an errand center clerk, dropping off a list or the like, however, in the preferred embodiment, selections are communicated to the system of the present invention by the Internet, and most preferably, through a merchant's Internet web site, 106.

One known selection means is by scanner. Data identifying a product available for consumer selection is embodied in a unique product code, or bar code, available to consumer access. Systems are known to provide consumers with hand held scanners for browsing retail stores and recording a list of selected items by scanning the unique product codes from their packages or shelves. See, U.S. Pat. Nos. 5,424,524; 6,101,483; and 6,123,259, the entire disclosure of which are hereby incorporated by reference. As with any other selection means, scanning selection means are intended to be compatiable with the present system, 104. This incorporation will encompass any of a variety of already described or to be developed systems, for example where a hand held scanner transfers data by synchronizing cradle or infared beam to a retail outlet system memory either at the retail outlet and thereafter connected to an errand center system memory, or directly through the Internet to the errand center system memory. Alternatively a wireless connection could be made for the same transfer of data identifying selected products. Alternatively, home scanning devices for capturing identifying data from the package of items already consumed may be used. In all events, the data corresponds to consumer selections for a current purchase order which are communicated to the system of the present invention, which communication is, in its preferred embodiment, through the Internet, 106.

After receiving a current purchase order the system memory of the present invention in a data structure comprising a memory unique to each individual participating consumer, will capture the consumer's ship to address, 108. If the current purchase order is received from a new consumer, the ship to address will be entered by that consumer in response to prompts.

The consumer ship to address is first checked to confirm availability of errand center courier service encompassing that address, 114. Shipping cost are next calculated, 116. These steps are performed by conventional means for comparing input data to a data structure in a memory. The ship to address is routed by the system processor of the present invention which takes into account data corresponding to known geography such as shipping routes, distances, traffic patterns and the like and also incorporates a current active memory for routing activity relevant to the shipping date, 118. Data processing techniques for optimal routing are known. See, U.S. Pat. Nos.: 5,450,317, 5,631,827, 6,003,010 and 6,029,140, the entire disclosure of which are hereby incorporated by reference.

Upon completion of the current purchase order, 120, the data is transferred to an active memory and a storage memory. The active short term memory is used to transmit the relevant data to the courier for display necessary to inform him of the pickup times and places and the drop off place, whether errand center or otherwise, 122. The data is also transferred from completion of the current purchase order to a long term memory, 124, which is used for maintaining a record of each individual consumer's purchases. This record is used to generate a preferred items list to streamline the consumer's entry of selections for the next purchase order and thereby promote consumer convenience. In the preferred embodiment, the stored data is also used for a subscription service which will automatically re-order items consumed on predictable periodic basis when such periods end, 126. Designation of these items is by consumer selection, 128. Those of skill in the art will appreciate that alternative entry means, for example, entry of an item onto a subscription list when current purchase data comparison algorithms find that a particular items is repetitively ordered on a periodic basis.

From the active memory, 122, a current purchase order is displayed to the courier to direct pick ups, aggregation and delivery to the local errand center. Simultaneously therewith, if ordered, existing long-distance shippers transport and deliver to the errand center current purchase items from outside the local errand center area, 130, 132, and 134.

The system of the present invention records a consumer's current purchase order. In the preferred embodiment this record is digital, and stored in a data structure embodied in a machine readable format and medium. Alternative embodiments include any temporary recording, for example, manual recording by a clerk taking a telephone order, or a consumer's manual order list dropped off for filling.

Although merchandisers may perform conventional telephone transactions within the contemplated system and method of the present invention, in its preferred embodiment a consumer will order goods through the merchandisers web site, either within or outside the errand center storefront local area. Hence, merchandisers may participate in the system at any level: without a web page, with a web page or with an integrated web page.

It is contemplated within the system and method of the present invention that an Application Programming Interface will be available to local and long distance merchants. This API will register a consumer, take their order, and automatically store the order into the errand center active storefront system memory as a unique current purchase order. From there it is displayed to direct courier aggregation activities. The display may be at the errand center storefront central dispatch, or by distributed display, as by wireless Internet, at distributed kiosk displays, or by conventional telephone, radio, manual or facsimile methods.

The API may further receive input of consumer elections as to the time and place of delivery, to home, office or errand center storefront.

The data in the separate unique stored memories will be accessible for various data mining activities generally oriented to customize service to an individual consumer, marketing of new products or options consumers and/or seeking efficiencies in delivery logistics. Hence the errand center system memory will be accessible to track any scaleable number of variables, for example, sales records by merchant, brand or model.

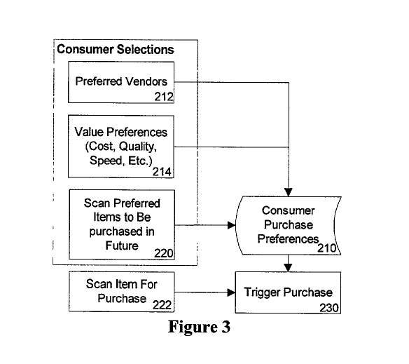

The preferred item list is unique to an individual consumer. A data structure, 128 in FIG. 2; 210 in FIG. 3, which is unique to each participating consumer, records preferred merchants, 212, and preferred products, including brand, quality, price constraints and the like, 214. Preferences may be displayed for the consumer on a list, so that items may be simply checked off to expedite ordering. Interactive display may be at the terminal of the errand center, retailer, kiosk, or portable wireless device, but preferably on a consumers home computer. Access may be via the Internet.

In another preferred embodiment items may be originally stored in the preferred items list by scanning them from any location, at home or in a store, at any time, 220. Thereafter, a purchase may be triggered, 230, either through preferred items list display and selection, or by scanning, 222.

It is contemplated that the present invention have a subscription service, 126, whereby consumers may record a period of time in which the fungible items are expected to be next needed, for example, milk in two days, cereal each week, or dog food each month, so that designated items are automatically added to a periodic order list.

The subscription service would be compatible with additions thereto from a current purchase order, a designation on the preferred items memory or directly through accessing and interactive errand center website display. Alternatively or additionally, a programmed search in correlation component of the present invention may isolate repetitive orders of a particular item by a particular consumer, and automatically transfer it to the subscription data structure, or display it to a consumer as a suggested item for the subscription data structure.

Actuation of the subscription orders would be achieved by simply transferring data corresponding to subscription items from the subscription memory via a subscription order controller to either a presently opened current purchase order, or to the system component for receiving consumer current purchase orders. Then, a current purchase order may be generated without consumer activity. Creation of a current purchase order to receive data corresponding to the subscription order items would occur automatically upon reaching the re-order time period corresponding to that item. The time period would be tracked by simple calendar memory and date tracking component according to known technologies.

It is contemplated that the present invention will be compatible with the addition of already known consumer sales data management technologies. These would include, by way of example and not limitation, shoppers alert systems for delivering price and other information to consumers relative to designated items, and on-line reverse auctions such as are known at “priceline.com” and “e-bay.”

According to the method and system of the present invention, data identifying items may be scanned for entry into various data structures. Retail shopping systems wherein a hand held scanner and memory device replace the traditional shopping cart are known. It is contemplated that the present invention would be compatible with such scanning of data corresponding to items selected for a current purchase order for entry into the errand center system memory, either through wireless Internet access, or data transfer at a retail store receiving device, typically a cradle at a customer service counter or kiosk.

Home scanners are known. After consuming an item, its Unique Product Code may be scanned so that it is recorded in a scanner memory, 21. Such scanning may also be made at any time and place with UPC's held in a memory of a hand held device to be synchronized with a kiosk, home computer or errand center storefront computer at a later time. Thus, when the consumer next links with the errand center storefront system memory, directly or through a retailer web page, with or without the API, the items scanned into memory are automatically added to the consumer current purchase order. If designated by the consumer, scanned data may also be entered into the preferred items list.

Kiosks distributed in the errand center storefront's local area at retailers' premises are contemplated within the method and system of the present invention. All the services mentioned herein may be actuated through these kiosks. The kiosks incorporate a computer terminal linking to the errand center storefront system memory and the Internet and the retailer's web page or other data base, if available. A cradle will be available for uploading scanned items from a memory and a hand held device, according to known technology.

In a preferred embodiment, the kiosk also will accept parcels for the consumer. This affords consumer convenience by having many pick up sites available and economy by creating a multitude of locations at which dropped off delivery items may be cached. This increases the likelihood that the location will be convenient to a consumer's commuter route, and a courier's aggregation route. Items may be dropped off either by long distance shipper directly, or an errand center storefront courier.

In view of the foregoing, it will be seen that the several advantages of the invention are achieved and attained. The embodiments were chosen and described in order to best explain the principles of the invention and its practical application to thereby enable other skilled in the art to best utilize the invention in various embodiments and with various modifications as are suited to the particular use contemplated.

As various modifications could be made in the systems and methods herein described and illustrated without departing from the scope of the invention, it is intended that all matter contained in the foregoing description are shown in the accompanying drawings shall be interpreted as illustrative rather than limiting. Thus, the breadth and scope of the present invention should not be limited by any of the above described exemplary embodiments, but should be defined only in accordance with the following claims appended hereto and their equivalents.

We claim:

1. A method of delivering consumer items comprising:
recording a current purchase order of the consumer;
scanning a unique product code for entering onto the current purchase order data identifying at least one item;
selecting at least one item for the current purchase order from an Internet web page;
aggregating one or more items on the current purchase order from at least one merchandiser within a local area;
bundling said aggregation of items with at least one item received from beyond said local area; and
retaining said items at an errand center storefront for retrieval by said consumer.

2. The method of claim 1 wherein said selecting is from the Internet web page of at least one merchant.

3. The method of claim 1 wherein said aggregating and said delivering are performed by a local courier.

4. The method of claim 1 wherein said errand center storefront is a kiosk.

5. The method of claim 1 wherein a subscription data structure automatically enters on recurrent purchase orders items designated by the consumer for periodic delivery at periods designated by the consumer, without any further action being necessary by the consumer after the consumer designates the item and delivery period for the subscription item.

6. A consumer items delivery system comprising:
a scanner for entering into said consumer memory list at least one item by scanning a unique product code for the item;
a record of items selected by the consumer as a current purchase order;
an interactive selection display for selecting at least one item for the current purchase order from an Internet web page;
a courier for aggregating items on the current purchase order from at least one merchant;
a depot for bundling said aggregation of items with at least one item received from beyond a local area; and
an errand center storefront for retaining said items for retrieval by said consumer.

7. The system of claim 6 wherein a subscription data structure automatically enters on recurrent purchase orders items designated by the consumer for periodic delivery at periods designated by the consumer, without any further action being necessary by the consumer after the consumer designates the item and delivery period for the subscription item.

8. The system of claim 6 wherein said errand center storefront is a Kiosk.

9. The system of claim 6 wherein the selections from said interactive display are from the Internet web page of at least one merchant.

10. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
selecting at least one item for the current purchase order from an Internet web page;
aggregating one or more items on the current purchase order from at least one merchandiser within a local area; and
retaining said items at an errand center storefront for retrieval by said consumer.

11. The method of claim 10 wherein said selecting is from the Internet web page of at least one merchant.

12. The method of claim 10 wherein said aggregating and said delivering are performed by a local courier.

13. The method of claim 10 wherein said errand center storefront is a kiosk.

14. The method of claim 10 wherein a subscription data structure automatically enters on recurrent purchase orders items designated by the consumer for periodic delivery at periods designated by the consumer, without any further action being necessary by the consumer after the consumer designates the item and delivery period for the subscription item.

15. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
an interactive selection display for selecting at least one item for the current purchase order from an Internet web page;
a courier for aggregating items on the current purchase order from at least one merchant; and
an errand center storefront for retaining said items for retrieval by said consumer.

16. The system of claim 15 wherein the selections from said interactive display are from the Internet web page of at least one merchant.

17. The system of claim 15 wherein said errand center storefront is a Kiosk.

18. The system of claim 15 wherein a subscription data structure automatically enters on recurrent purchase orders items designated by the consumer for periodic delivery at periods designated by the consumer, without any further action being necessary by the consumer after the consumer designates the item and delivery period for the subscription item.

19. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
selecting at least one item for the current purchase order from an Internet web page;
bundling items from merchants in a local area with at least one item received from beyond said local area; and
retaining said items at an errand center storefront for retrieval by said consumer.

20. The method of claim 19 wherein said selecting is from the Internet web page of at least one merchant.

21. The method of claim 19 wherein said aggregating and said delivering are performed by a local courier.

22. The method of claim 19 wherein said errand center storefront is a kiosk.

23. The method of claim 19 wherein a subscription data structure automatically enters on recurrent purchase orders items designated by the consumer for periodic delivery at periods designated by the consumer, without any further action being necessary by the consumer after the consumer designates the item and delivery period for the subscription item.

24. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
an interactive selection display for selecting at least one item for the current purchase order from an Internet web page;
a depot for bundling said aggregation of items with at least one item received from beyond a local area; and
an errand center storefront for retaining said items for retrieval by said consumer.

25. The system of claim 24 wherein the selections from said interactive display are from the Internet web page of at least one merchant.

26. The system of claim 24 wherein said errand center storefront is a Kiosk.

27. The system of claim 24 wherein a subscription data structure automatically enters on recurrent purchase orders items designated by the consumer for periodic delivery at periods designated by the consumer, without any further action being necessary by the consumer after the consumer designates the item and delivery period for the subscription item.

28. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
selecting at least one item for the current purchase order from an Internet web page;
aggregating one or more items on the current purchase order from at least one merchandiser within a local area;
bundling items from merchants in a local area with at least one item received from beyond the local area; and
retaining said items at an errand center storefront for retrieval by the consumer.

29. The method of claim 28 wherein said aggregating is performed by a local courier.

30. The method of claim 28 wherein said delivering is to a kiosk.

31. The method of claim 28 wherein a subscription data structure automatically enters on recurrent purchase orders items designated by the consumer for periodic delivery at periods designated by the consumer, without any further action being necessary by the consumer after the consumer designates the item and delivery period for the subscription item.

32. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
an interactive selection display for selecting at least one item for the current purchase order from an Internet web page;
a courier for aggregating items on the current purchase order from at least one merchant in a local area;
a depot for bundling said aggregation of items with at least one item received from beyond the local area; and
an errand center storefront for retaining said items for retrieval by said consumer.

33. The system of claim 32 wherein the selections from said interactive display are from the Internet web page of at least one merchant.

34. The system of claim 32 wherein said errand center storefront is a Kiosk.

35. The system of claim 32 wherein a subscription data structure automatically enters on recurrent purchase orders items designated by the consumer for periodic delivery at periods designated by the consumer, without any further action being necessary by the consumer after the consumer designates the item and delivery period for the subscription item.

36. A method of delivering consumer items comprising:
ordering by a consumer of one or more items from at least two merchandisers within a local area, said ordering being made on the Internet; and
retaining said items at an errand center storefront for retrieval by the consumer.

37. The method of claim 36 wherein a local courier delivers the order to the errand center storefront.

38. The method of claim 36 wherein said errand center storefront is a kiosk.

39. The method of claim 36 wherein a subscription data structure automatically enters on recurrent purchase orders items designated by the consumer for periodic delivery at periods designated by the consumer, without any further action being necessary by the consumer after the consumer designates the item and delivery period for the subscription item.

40. The method of claim 36 wherein said selecting is from the Internet web page of at least one merchant.

41. A consumer items delivery system comprising:
an interactive selection display for ordering at least one item by a consumer from an Internet web page; and
an errand center storefront for retaining said items for later retrieval by said consumer.

42. The system of claim 41 wherein said errand center storefront is a kiosk.

43. The system of claim 41 wherein a subscription data structure automatically enters on recurrent purchase orders items designated by the consumer for periodic delivery at periods designated by the consumer, without any further action being necessary by the consumer after the consumer designates the item and delivery period for the subscription item.

44. The system of claim 41 wherein the selections from said interactive display are from the Internet web page of at least one merchant.

45. A method of delivering consumer items comprising:
storing in a consumer memory a consumer list, said consumer memory being unique to the consumer, and said consumer memory having a data structure saving in memory after delivery at least one preferred item;
selecting by said consumer of items for purchase including at least of one of the items saved on said data structure memory; and
retaining said items at an errand center storefront for later retrieval by said consumer.

46. The method of claim 45 wherein a local courier delivers the consumer selections to the errand center storefront.

47. The method of claim 45 wherein said errand center storefront is a kiosk.

48. The method of claim 45 wherein a subscription data structure automatically enters on recurrent purchase orders items designated by the consumer for periodic delivery at periods designated by the consumer, without any further action being necessary by the consumer after the consumer designates the item and delivery period for the subscription item.

49. A consumer items delivery system comprising:
a consumer memory storing a consumer list, said consumer memory being unique to a said consumer, and said consumer memory having a data structure saving in memory after delivery at least one preferred item;
an errand center storefront for retaining items selected from said memory for later retrieval by said consumer.

50. The system of claim 49 wherein said errand center storefront is a kiosk.

51. The system of claim 49 wherein a subscription data structure automatically enters on recurrent purchase orders items designated by the consumer for periodic delivery at periods designated by the consumer, without any further action being necessary by the consumer after the consumer designates the item and delivery period for the subscription item.

52. A method of delivering consumer items comprising:
scanning a unique product code for entering into a consumer memory data identifying items for purchase by the unique product code; and
retaining said items at an errand center storefront for retrieval by said consumer.

53. The method of claim 52 wherein a local courier delivers the consumer selections to the errand center storefront.

54. The method of claim 52 wherein said errand center storefront is a kiosk.

55. The method of claim 52 wherein a subscription data structure automatically enters on recurrent purchase orders items designated by the consumer for periodic delivery at periods designated by the consumer, without any further action being necessary by the consumer after the consumer designates the item and delivery period for the subscription item.

56. A consumer items delivery system comprising:
a scanner for entering into a consumer memory data identifying items for purchase by the unique product code; and
an errand center storefront for retaining said items for later retrieval by said consumer.

57. The system of claim 56 wherein said errand center storefront is a kiosk.

58. The system of claim 56 wherein a subscription data structure automatically enters on recurrent purchase orders items designated by the consumer for periodic delivery at periods designated by the consumer, without any further action being necessary by the consumer after the consumer designates the item and delivery period for the subscription item.

59. A method of delivering consumer items comprising:
aggregating one or more items from at least two retailers within a local area, said items being known to be selections of a consumer;
bundling said aggregation of items with at least one item received from beyond said local area; and
delivering said bundle of received and aggregated items to the consumer.

60. The method of claim 59 wherein said aggregation is performed by a local courier.

61. The method of claim 59 wherein a subscription data structure automatically enters on recurrent purchase orders items designated by the consumer for periodic delivery at periods designated by the consumer, without any further action being necessary by the consumer after the consumer designates the item and delivery period for the subscription item.

62. A consumer items delivery system comprising:
a courier for aggregating and delivering items known to be a consumer's selections;
a depot for bundling said aggregation of items with at least one item received from beyond said local area.

63. The system of claim 62 wherein the selections from said interactive display are from the Internet web page of at least one merchant.

64. The system of claim 62 wherein a subscription data structure automatically enters on recurrent purchase orders items designated by the consumer for periodic delivery at periods designated by the consumer, without any further action being necessary by the consumer after the consumer designates the item and delivery period for the subscription item.

65. A method of delivering consumer items comprising:
aggregating one or more pre-determined items from at least two merchants within a local area, said items being known to be selections of a consumer; and
retaining said items at an errand center storefront for retrieval by the consumer.

66. The method of claim 65 wherein said aggregation is performed by a local courier.

67. The method of claim 65 wherein a subscription data structure automatically enters on recurrent purchase orders items designated by the consumer for periodic delivery at periods designated by the consumer, without any further action being necessary by the consumer after the consumer designates the item and delivery period for the subscription item.

68. A consumer items delivery system comprising:
a courier for aggregating one or more pre-determined items from at least two merchants within a local area, said items being known to be selections of a consumer; and;
an errand center storefront for retaining said items for later retrieval by said consumer.

69. The system of claim 68 wherein said errand center storefront is a kiosk.

70. The system of claim 68 wherein a subscription data structure automatically enters on recurrent purchase orders items designated by the consumer for periodic delivery at periods designated by the consumer, without any further action being necessary by the consumer after the consumer designates the item and delivery period for the subscription item.

71. A method of delivering consumer items comprising:
ordering by a consumer of one or more items from at least two merchandisers, said ordering being made on the Internet;
aggregating said one or more ordered items; and
delivering said aggregation of items to said consumer.

72. The method of claim 71 wherein said aggregation is made by a courier.

73. The method of claim 71 wherein said delivery is made to a kiosk.

74. The method of claim 71 wherein a subscription data structure automatically enters on recurrent purchase orders items designated by the consumer for periodic delivery at periods designated by the consumer, without any further action being necessary by the consumer after the consumer designates the item and delivery period for the subscription item.

75. A consumer items delivery system comprising:
an interactive display for selecting at least of one item from an Internet web page;
a courier for aggregating and delivering said consumer selections;

76. The system of claim 75 wherein a subscription data structure automatically enters on recurrent purchase orders items designated by the consumer for periodic delivery at periods designated by the consumer, without any further action being necessary by the consumer after the consumer designates the item and delivery period for the subscription item.

77. The system of claim 75 wherein the selections from said interactive display are from the Internet web page of at least one merchant.

78. A method of delivering consumer items comprising:
storing in a consumer memory at least one item selected by a consumer, said consumer memory being unique to said consumer, and said consumer memory having a data structure saving in memory after delivery at least one preferred item;
aggregating said consumer selections; and
delivering to said consumer said aggregation of said selected items.

79. The method of claim 78 wherein said aggregation is made by a courier.

80. The method of claim 78 wherein a subscription data structure automatically enters on recurrent purchase orders items designated by the consumer for periodic delivery at periods designated by the consumer, without any further action being necessary by the consumer after the consumer designates the item and delivery period for the subscription item.

81. A consumer items delivery system comprising:
a consumer memory storing at least one item selected by a consumer, said consumer memory being unique to a said consumer, and said consumer memory having at least one preferred item from at least one merchant;
a courier for aggregating and delivering said consumer selections;

82. The system of claim 81 wherein a subscription data structure automatically enters on recurrent purchase orders items designated by the consumer for periodic delivery at periods designated by the consumer, without any further action being necessary by the consumer after the consumer designates the item and delivery period for the subscription item.

83. A method of delivering consumer good comprising:
scanning a unique product code for entering onto a consumer memory the item identified by the unique product code;
aggregating at least two items known to be the consumers purchase selections, at least one of the items being from said consumer memory; and
delivering said aggregation of said items to said consumer.

84. The method of any of claim 83 wherein said aggregation is performed by a courier.

85. A consumer items delivery system comprising:
a scanner for entering into a consumer memory at least one item by scanning a unique product code for the item; and
a courier for aggregating at least two items known to be the consumers purchase selections, from at least two merchandisers, at least one of the items being from said consumer memory of consumer selections and said courier delivering the selections to the consumer.

86. The system of claim 85 wherein a subscription data structure automatically enters on recurrent purchase orders items designated by the consumer for periodic delivery at periods designated by the consumer, without any further action being necessary by the consumer after the consumer designates the item and delivery period for the subscription item.

87. A method of delivering consumer items comprising:
aggregating one or more pre-determined items from at least two merchandisers within a local area, said items being known to be selections of a consumer;
bundling said aggregation of items with at least one item received from beyond said local area; and
retaining said bundle of received and aggregated items an errand center storefront for retrieval by the consumer.

88. The method of claim 87 wherein said aggregation is performed by a local courier.

89. The method of claim 87 wherein said consumer said selections from said merchants web site are automatically recorded to a system memory having a display of said selections for directing said aggregation.

90. The method of claim 87 wherein a subscription data structure automatically enters on recurrent purchase orders items designated by the consumer for periodic delivery at periods designated by the consumer, without any further action being necessary by the consumer after the consumer designates the item and delivery period for the subscription item.

91. A consumer items delivery system comprising:
a courier for aggregating at least two items selected by a consumer;
a depot for bundling said aggregation of items with at least one item received from beyond a local area; and
an errand center storefront for retaining said items for retrieval by said consumer.

92. The system of claim 91 wherein said errand center storefront is a kiosk.

93. The system of claim 91 wherein a subscription data structure automatically enters on recurrent purchase orders items designated by the consumer for periodic delivery at periods designated by the consumer, without any further action being necessary by the consumer after the consumer designates the item and delivery period for the subscription item.

94. A method of delivering consumer items comprising:
recording a current purchase order of the consumer, the order including at least one item corresponding to said stored preferred item data;
selecting at least one item for the current purchase order from an Internet web page;
aggregating one or more items on the current purchase order from at least one merchandiser within a local area;
bundling items from merchants in a local area with at least one item received from beyond the local area; and
delivering said bundle of received and aggregated items to said consumer.

95. The method of claim 94 wherein said aggregating and said delivering is performed by a local courier.

96. The method of claim 94 wherein said delivering is to a kiosk.

97. The method of claim 94 wherein a subscription data structure automatically enters on recurrent purchase orders items designated by the consumer for periodic delivery at periods designated by the consumer, without any further action being necessary by the consumer after the consumer designates the item and delivery period for the subscription item.

98. A consumer items delivery system comprising:
a record of items selected by the consumer as a current purchase order, said record including at least one preferred item;
an interactive selection display for selecting at least one item for the current purchase order from an Internet web page;
a courier for aggregating items on the current purchase order from at least one merchant in a local area;
a depot for bundling said aggregation of items with at least one item received from beyond the local area; and
a courier for delivering said bundled and said aggregated items to the consumer.

99. The system of claim 98 wherein a subscription data structure automatically enters on recurrent purchase orders items designated by the consumer for periodic delivery at periods designated by the consumer, without any further action being necessary by the consumer after the consumer designates the item and delivery period for the subscription item.

100. The system of claim 98 wherein said delivering is to a kiosk.

101. The system of claim 98 wherein the selections from said interactive display are from the Internet web page of at least one merchant.

102. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
aggregating one or more items on the current purchase order from at least two merchandisers within a local area;
bundling said aggregation of items with at least one item received from beyond said local area; and
delivering said bundle of received and aggregated items to said consumer.

103. The method of claim 102 wherein said aggregating and said delivering is performed by a local courier.

104. The method of claim 102 wherein said delivering is to a kiosk.

105. The method of claim 102 wherein a subscription data structure automatically enters on recurrent purchase orders items designated by the consumer for periodic delivery at periods designated by the consumer, without any further action being necessary by the consumer after the consumer designates the item and delivery period for the subscription item.

106. A consumer items delivery system comprising:
a data structure storing information identifying at least one item designated by the consumer as a preferred item;
a record of items selected by the consumer as a current purchase order, said record including at least one preferred item;
a courier for aggregating items on the current purchase order from at least one merchant in a local area;
a depot for bundling said aggregation of items with at least one item received from beyond the local area; and
a courier for delivering the current purchase order items to the consumer.

107. The method of claim 106 wherein a subscription data structure automatically enters on recurrent purchase orders items designated by the consumer for periodic delivery at periods designated by the consumer, without any further action being necessary by the consumer after the consumer designates the item and delivery period for the subscription item.

108. The system of claim 106 wherein said delivering is to a kiosk.

109. A method of delivering consumer items comprising:
recording a current purchase order of the consumer, the order including at least one item corresponding to said stored preferred item data;
scanning a unique product code for entering onto the current purchase order data identifying at least one item;
aggregating one or more items on the current purchase order from at least one merchandiser within a local area;
bundling items from merchants in a local area with at least one item received from beyond the local area; and
delivering said bundle of received and aggregated items to the consumer.

110. The method of claim 109 wherein said aggregating and said delivering are performed by a local courier.

111. The method of claim 109 wherein said delivering is to a kiosk.

112. The method of claim 109 wherein a subscription data structure automatically enters on recurrent purchase orders items designated by the consumer for periodic delivery at periods designated by the consumer, without any further action being necessary by the consumer after the consumer designates the item and delivery period for the subscription item.

113. A consumer items delivery system comprising:
a record of items selected by the consumer as a current purchase order, said record including at least one preferred item;
a scanner for entering into the current purchase order data identifying at least one item by scanning a unique product code for the item;
a courier for aggregating items on the current purchase order from at least one merchant in a local area;
a depot for bundling said aggregation of items with at least one item received from beyond the local area; and
a courier for delivering the current purchase order items to the consumer.

114. The system of claim 113 wherein a subscription data structure automatically enters on recurrent purchase orders items designated by the consumer for periodic delivery at periods designated by the consumer, without any further action being necessary by the consumer after the consumer designates the item and delivery period for the subscription item.

115. The system of claim 113 wherein said delivering is to a kiosk.

116. A method of delivering consumer items comprising:
recording a current purchase order of the consumer, the order including at least one item corresponding to said stored preferred item data;
selecting at least one item for the current purchase order from an Internet web page;
bundling current purchase order items from merchants in a local area with at least one item received from beyond the local area; and
retaining the items at an errand center storefront for retrieval by the consumer.

117. The method of claim 116 wherein said errand center storefront is a kiosk.

118. The method of claim 116 wherein a subscription data structure automatically enters on recurrent purchase orders items designated by the consumer for periodic delivery at periods designated by the consumer, without any further action being necessary by the consumer after the consumer designates the item and delivery period for the subscription item.

119. A consumer items delivery system comprising:
a record of items selected by the consumer as a current purchase order, said record including at least one preferred item;
an interactive selection display for selecting at least one item for the current purchase order from an Internet web page;
a depot for bundling current purchase order items from merchants within a local area with at least one item received from beyond the local area; and
an errand center storefront for retaining said items for retrieval by said consumer.

120. The system of claim 119 wherein said errand center storefront is a kiosk.

121. The system of claim 119 wherein a subscription data structure automatically enters on recurrent purchase orders items designated by the consumer for periodic delivery at periods designated by the consumer, without any further action being necessary by the consumer after the consumer designates the item and delivery period for the subscription item.

122. The system of claim 119 wherein the selections from said interactive display are from the Internet web page of at least one merchant.

123. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
bundling current purchase order items from merchants within a local area with at least one item received from beyond the local area; and
retaining said items at an errand center storefront for retrieval by the consumer.

124. The method of claim 123 wherein said aggregating and said delivering is performed by a local courier.

125. The method of claim 123 wherein said delivering is to a kiosk.

126. The method of claim 123 wherein a subscription data structure automatically enters on recurrent purchase orders items designated by the consumer for periodic delivery at periods designated by the consumer, without any further action being necessary by the consumer after the consumer designates the item and delivery period for the subscription item.

127. A consumer items delivery system comprising:
a data structure storing information identifying at least one item designated by the consumer as a preferred item;
a record of items selected by the consumer as a current purchase order, said record including at least one preferred item;
a depot for bundling current purchase order items from merchants within a local area with at least one item received from beyond the local area; and
an errand center storefront for retaining said items for retrieval by said consumer.

128. The system of claim 127 wherein said errand center storefront is a kiosk.

129. The system of claim 127 wherein a subscription data structure automatically enters on recurrent purchase orders items designated by the consumer for periodic delivery at periods designated by the consumer, without any further action being necessary by the consumer after the consumer designates the item and delivery period for the subscription item.

130. A method of delivering consumer items comprising:
recording a current purchase order of the consumer,;
scanning a unique product code for entering onto the current purchase order data identifying at least one item;
bundling current purchase order items from merchants in a local area with at least one item received from beyond the local area; and
retaining said items at an errand center storefront for retrieval by the consumer.

131. The method of claim 130 wherein said bundling is performed by a local courier.

132. The method of claim 130 wherein said errand center storefront is a kiosk.

133. The method of claim 130 wherein a subscription data structure automatically enters on recurrent purchase orders items designated by the consumer for periodic delivery at periods designated by the consumer, without any further action being necessary by the consumer after the consumer designates the item and delivery period for the subscription item.

134. A consumer items delivery system comprising:
a record of items selected by the consumer as a current purchase order,;
a scanner for entering into the current purchase order data identifying at least one item by scanning a unique product code for the item;
a depot for bundling current purchase order items with at least one item received from beyond the local area; and
an errand center storefront for retaining said items for retrieval by said consumer.

135. The system of claim 134 wherein said errand center storefront is a kiosk.

136. The system of claim 134 wherein a subscription data structure automatically enters on recurrent purchase orders items designated by the consumer for periodic delivery at periods designated by the consumer, without any further action being necessary by the consumer after the consumer designates the item and delivery period for the subscription item.

137. A method of delivering consumer items comprising:
recording a current purchase order of the consumer,;
selecting at least one item for the current purchase order from an Internet web page;
aggregating one or more items on the current purchase order from at least one merchandiser; and
retaining said items at an errand center storefront for retrieval by said consumer.

138. The method of claim 137 wherein said selecting is from the Internet web page of at least one merchant.

139. The method of claim 137 wherein said aggregating is performed by a local courier.

140. The method of claim 137 wherein said errand center storefront is a kiosk.

141. The method of claim 137 wherein a subscription data structure automatically enters on recurrent purchase orders items designated by the consumer for periodic delivery at periods designated by the consumer, without any further action being necessary by the consumer after the consumer designates the item and delivery period for the subscription item.

142. A consumer items delivery system comprising:
a record of items selected by the consumer as a current purchase order,;
an interactive selection display for selecting at least one item for the current purchase order from an Internet web page;
a courier for aggregating items on the current purchase order from at least one merchant; and
an errand center storefront for retaining said items for retrieval by said consumer.

143. The system of claim 142 wherein said errand center storefront is a kiosk.

144. The system of claim 142 wherein a subscription data structure automatically enters on recurrent purchase orders items designated by the consumer for periodic delivery at periods designated by the consumer, without any further action being necessary by the consumer after the consumer designates the item and delivery period for the subscription item.

145. The system of claim 142 wherein the selections from said interactive display are from the Internet web page of at least one merchant.

146. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
aggregating one or more items on the current purchase order from at least one merchandiser within a local area; and
retaining said items at an errand center storefront for retrieval by the consumer.

147. The method of claim 146 wherein said aggregating and said delivering is performed by a local courier.

148. The method of claim 146 wherein said delivering is to a kiosk.

149. The method of claim 146 wherein a subscription data structure automatically enters on recurrent purchase orders items designated by the consumer for periodic delivery at periods designated by the consumer, without any further action being necessary by the consumer after the consumer designates the item and delivery period for the subscription item.

150. A consumer items delivery system comprising:
a data structure storing information identifying at least one item designated by the consumer as a preferred item;
a record of items selected by the consumer as a current purchase order, said record including at least one preferred item;
a courier for aggregating items on the current purchase order from at least one merchant; and
an errand center storefront for retaining said items for retrieval by said consumer.

151. The system of claim 150 wherein said errand center storefront is a kiosk.

152. The system of claim 150 wherein a subscription data structure automatically enters on recurrent purchase orders items designated by the consumer for periodic delivery at periods designated by the consumer, without any further action being necessary by the consumer after the consumer designates the item and delivery period for the subscription item.

153. A method of delivering consumer items comprising:
recording a current purchase order of the consumer, the order including at least one item corresponding to said stored preferred item data;
scanning a unique product code for entering onto the current purchase order data identifying at least one item;
aggregating one or more items on the current purchase order from at least one merchandiser within a local area; and
retaining said items at an errand center storefront for retrieval by the consumer.

154. The method of claim 153 wherein said aggregating is performed by a local courier.

155. The method of claim 153 wherein said delivering is to a kiosk.

156. The method of claim 153 wherein a subscription data structure automatically enters on recurrent purchase orders items designated by the consumer for periodic delivery at periods designated by the consumer, without any further action being necessary by the consumer after the consumer designates the item and delivery period for the subscription item.

157. A consumer items delivery system comprising:
a record of items selected by the consumer as a current purchase order, said record including at least one preferred item;
a scanner for entering into the current purchase order data identifying at least one item by scanning a unique product code for the item;
a courier for aggregating items on the current purchase order from at least one merchant in a local area; and
an errand center storefront for retaining said items for retrieval by said consumer.

158. The system of claim 157 wherein said errand center storefront is a kiosk.

159. The system of claim 157 wherein a subscription data structure automatically enters on recurrent purchase orders items designated by the consumer for periodic delivery at periods designated by the consumer, without any further action being necessary by the consumer after the consumer designates the item and delivery period for the subscription item.

160. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
selecting at least one item for the current purchase order from an Internet web page;
aggregating one or more items on the current purchase order from at least one merchandiser;
delivering to said consumer said aggregation of current purchase order items.

161. The method of claim 160 wherein said selecting is from the Internet web page of at least one merchant.

162. The method of claim 160 wherein said aggregating and said delivering are performed by a local courier.

163. The method of claim 160 wherein said delivering is to a kiosk.

164. The method of claim 160 wherein a subscription data structure automatically enters on recurrent purchase orders items designated by the consumer for periodic delivery at periods designated by the consumer, without any further action being necessary by the consumer after the consumer designates the item and delivery period for the subscription item.

165. A consumer items delivery system comprising:
a data structure storing information identifying at least one item designated by the consumer as a preferred item;
a record of items selected by the consumer as a current purchase order, said record including at least one preferred item;
an interactive selection display for selecting at least one item for the current purchase order from an Internet web page;
a courier for aggregating items on the current purchase order from at least one merchant and delivering the current purchase order to the consumer.

166. The system of claim 165 wherein a subscription data structure automatically enters on recurrent purchase orders items designated by the consumer for periodic delivery at periods designated by the consumer, without any further action being necessary by the consumer after the consumer designates the item and delivery period for the subscription item.

167. The system of claim 165 wherein the selections from said interactive display are from the Internet web page of at least one merchant.

168. The system of claim 165 wherein said delivering is to a kiosk.

169. A method of delivering consumer items comprising:
recording a current purchase order of the consumer, the order including at least one item corresponding to said stored preferred item data;
scanning a unique product code for entering onto the current purchase order data identifying at least one item;
selecting at least one item for the current purchase order from an Internet web page;
aggregating one or more items on the current purchase order from at least one merchandiser; and
delivering said aggregation of items to said consumer.

170. The method of claim 169 wherein said aggregating and said delivering are performed by a local courier.

171. The method of claim 169 wherein said delivering is to a kiosk.

172. The method of claim 169 wherein a subscription data structure automatically enters on recurrent purchase orders items designated by the consumer for periodic delivery at periods designated by the consumer, without any further action being necessary by the consumer after the consumer designates the item and delivery period for the subscription item.

173. A consumer items delivery system comprising:
a record of items selected by the consumer as a current purchase order, said record including at least one preferred item;
a scanner for entering into the current purchase order data identifying at least one item by scanning a unique product code for the item;
an interactive selection display for selecting at least one item for the current purchase order from an Internet web page;
a courier for aggregating items on the current purchase order from at least one merchant and delivering the items on the current purchase order to the consumer.

174. The system of claim 173 wherein a subscription data structure automatically enters on recurrent purchase orders items designated by the consumer for periodic delivery at periods designated by the consumer, without any further action being necessary by the consumer after the consumer designates the item and delivery period for the subscription item.

175. The system of claim 173 wherein the selections from said interactive display are from the Internet web page of at least one merchant.

176. The system of claim 173 wherein said delivering is to a kiosk.

177. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
aggregating one or more items on the current purchase order from at least one merchandiser; and
delivering said aggregation of items to the consumer.

178. The method of claim 177 wherein said aggregating and said delivering are performed by a local courier.

179. The method of claim 177 wherein said delivering is to a kiosk.

180. The method of claim 177 wherein a subscription data structure automatically enters on recurrent purchase orders items designated by the consumer for periodic delivery at periods designated by the consumer, without any further action being necessary by the consumer after the consumer designates the item and delivery period for the subscription item.

181. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
a courier for aggregating items on the current purchase order from at least one merchant and delivering the current purchase order items to the consumer.

182. The system of claim 181 wherein a subscription data structure automatically enters on recurrent purchase orders items designated by the consumer for periodic delivery at periods designated by the consumer, without any further action being necessary by the consumer after the consumer designates the item and delivery period for the subscription item.

183. The system of claim 181 wherein said delivering is to a kiosk.

184. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
selecting at least one item for the current purchase order from an Internet web page;
bundling items from merchants in a local area with at least one item received from beyond the local area; and
delivering said bundle of current purchase order items to the consumer.

185. The method of claim 184 wherein said selecting is from the Internet web page of at least one merchant.

186. The method of claim 184 wherein said delivering is performed by a local courier.

187. The method of claim 184 wherein said delivering is to a kiosk.

188. The method of claim 184 wherein a subscription data structure automatically enters on recurrent purchase orders items designated by the consumer for periodic delivery at periods designated by the consumer, without any further action being necessary by the consumer after the consumer designates the item and delivery period for the subscription item.

189. A consumer items delivery system comprising:
a data structure storing information identifying at least one item designated by the consumer as a preferred item;
a record of items selected by the consumer as a current purchase order, said record including at least one preferred item;
an interactive selection display for selecting at least one item for the current purchase order from an Internet web page;
a depot for bundling current purchase order items with at least one item received from beyond the local area.

190. The system of claim 189 wherein a subscription data structure automatically enters on recurrent purchase orders items designated by the consumer for periodic delivery at periods designated by the consumer, without any further action being necessary by the consumer after the consumer designates the item and delivery period for the subscription item.

191. The system of claim 189 wherein the selections from said interactive display are from the Internet web page of at least one merchant.

192. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
selecting at least one item for the current purchase order from an Internet web page;
receiving current purchase order items at an errand center storefront; and
distributing to the consumer current purchase order items at said errand center storefront.

193. The method of claim 192 wherein said errand center storefront is to a kiosk.

194. The method of claim 192 wherein a subscription data structure automatically enters on recurrent purchase orders items designated by the consumer for periodic delivery at periods designated by the consumer, without any further action being necessary by the consumer after the consumer designates the item and delivery period for the subscription item.

195. A consumer items delivery system comprising:
a data structure storing information identifying at least one item designated by the consumer as a preferred item;
a record of items selected by the consumer as a current purchase order, said record including at least one preferred item;
an interactive selection display for selecting at least one item for the current purchase order from an Internet web page;
an errand center storefront for retaining current purchase order items for retrieval by the consumer.

196. The system of claim 195 wherein a subscription data structure automatically enters on recurrent purchase orders items designated by the consumer for periodic delivery at periods designated by the consumer, without any further action being necessary by the consumer after the consumer designates the item and delivery period for the subscription item.

197. The system of claim 195 wherein said errand center storefront is a Kiosk.

198. The system of claim 195 wherein the selections from said interactive display are from the Internet web page of at least one merchant.

199. A method of delivering consumer items comprising:
recording a current purchase order of the consumer, the order including at least one item corresponding to said stored preferred item data;
scanning a unique product code for entering onto the current purchase order data identifying at least one item;
selecting at least one item for the current purchase order from an Internet web page;
receiving the current purchase order at an errand center storefront; and
distributing to said one or more consumers said one or more ordered items at said errand center storefront.

200. The method of claim 199 wherein said selecting is from the Internet web page of at least one merchant.

201. The method of claim 199 wherein said errand center storefront is to a kiosk.

202. The method of claim 199 wherein a subscription data structure automatically enters on recurrent purchase orders items designated by the consumer for periodic delivery at periods designated by the consumer, without any further action being necessary by the consumer after the consumer designates the item and delivery period for the subscription item.

203. A consumer items delivery system comprising:
a record of items selected by the consumer as a current purchase order;
a scanner for entering into the current purchase order data identifying at least one item by scanning a unique product code for the item;
an interactive selection display for selecting at least one item for the current purchase order from an Internet web page; and
an errand center storefront for retaining said items for retrieval by said consumer.

204. The system of claim 203 wherein a subscription data structure automatically enters on recurrent purchase orders items designated by the consumer for periodic delivery at periods designated by the consumer, without any further action being necessary by the consumer after the consumer designates the item and delivery period for the subscription item.

205. The system of claim 204 wherein said errand center storefront is a Kiosk.

206. The system of claim 204 wherein the selections from said interactive display are from the Internet web page of at least one merchant.

207. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code of at least one item to record data identifying the item in the current purchase order;
aggregating one or more items on the current purchase order from at least one merchandiser within a local area; and
retaining said items at an errand center storefront for retrieval by said consumer.

208. The method of claim 207 wherein said aggregating is performed by a local courier.

209. The method of claim 207 wherein said errand center storefront is a kiosk.

210. The method of claim 207 wherein a subscription data structure automatically enters on recurrent purchase orders items designated by the consumer for periodic delivery at periods designated by the consumer, without any further action being necessary by the consumer after the consumer designates the item and delivery period for the subscription item.

211. A consumer items delivery system comprising:
a data structure storing information identifying an item designated by the consumer as a preferred item;
a record of items selected by the consumer as a current purchase order, said record including at least one preferred item;
a scanner for entering into a current purchase order at least one item by scanning a unique product code identifying the item; and
an errand center storefront for retaining said items for retrieval by said consumer.

212. The system of claim 211 wherein a subscription data structure automatically enters on recurrent purchase orders items designated by the consumer for periodic delivery at periods designated by the consumer, without any further action being necessary by the consumer after the consumer designates the item and delivery period for the subscription item.

213. The system of claim 211 wherein said errand center storefront is a Kiosk.

214. A method of delivering consumer items comprising:
selecting at least of one item from an Internet web page;
aggregating one or more pre-determined items from at least two merchandisers within a local area, said items being known to be selections of a consumer;
bundling said aggregation of items with at least one item received from beyond said local area; and
retaining said items at an errand center storefront for retrieval by said consumer.

215. The method of claim 214 wherein said selecting is from the Internet web page of at least one merchant.

216. The method of claim 214 wherein said aggregating and said delivering is performed by a local courier.

217. The method of claim 214 wherein said delivering is to a kiosk.

218. The method of claim 214 wherein a subscription data structure automatically enters on recurrent purchase orders items designated by the consumer for periodic delivery at periods designated by the consumer, without any further action being necessary by the consumer after the consumer designates the item and delivery period for the subscription item.

219. A consumer items delivery system comprising:
an interactive selection display for selecting at least one item from an Internet web page;
a courier for aggregating consumer selections from merchants within a local area;
a depot for bundling said aggregation of items with at least one item received from beyond the lo
an errand center storefront for retaining the aggregated and bundled items for retrieval by the consumer.

220. The system of claim 219 wherein a subscription data structure automatically enters on recurrent purchase orders items designated by the consumer for periodic delivery at periods designated by the consumer, without any further action being necessary by the consumer after the consumer designates the item and delivery period for the subscription item.

221. The system of claim 219 wherein said errand center storefront is a Kiosk.

222. The system of claim 219 wherein the selections from said interactive display are from the Internet web page of at least one merchant.

223. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
aggregating one or more items on the current purchase order from at least one merchandiser within a local area;
bundling said aggregation of items with at least one item received from beyond the local area; and
retaining the items at an errand center storefront for retrieval by the consumer.

224. The method of claim 223 wherein said aggregating is performed by a local courier.

225. The method of claim 223 wherein said errand center storefront is a kiosk.

226. The method of claim 223 wherein a subscription data structure automatically enters on recurrent purchase orders items designated by the consumer for periodic delivery at periods designated by the consumer, without any further action being necessary by the consumer after the consumer designates the item and delivery period for the subscription item.

227. The method of claim 223 wherein said storing is performed by scanning a unique product code embodying the data identifying the preferred item.

228. The method of claim 223 wherein said recording is performed by scanning a unique product code embodying the data identifying at least one preferred item.

229. A consumer item delivery system comprising:
a data structure storing information identifying at least one item designated by the consumer as a preferred item;
a record of items selected by the consumer as a current purchase order, said record including at least one preferred item;
a courier for aggregating at least one consumer selection from a local merchant in a local area;
a depot for bundling said aggregation of items with at least one item received from beyond said local area; and
an errand center storefront for retaining said items for retrieval by said consumer.

230. The system of claim 229 wherein a subscription data structure automatically enters on recurrent purchase orders items designated by the consumer for periodic delivery at periods designated by the consumer, without any further action being necessary by the consumer after the consumer designates the item and delivery period for the subscription item.

231. The system of claim 229 wherein said errand center storefront is a Kiosk.

232. The system of claim 229 wherein preferred item identifying data is entered into said data structure by scanning a unique product code embodying data identifying the preferred item.

233. The system of claim 229 wherein at least one item entered by the consumer onto said record of item selected for a current purchase order is entered by the consumer by scanning a unique product code embodying data identifying the selected item.

234. A method of delivering consumer items comprising:
recording a current purchase order of a consumer;
scanning a unique product code of at least one item to record data identifying the item in the current purchase order;
aggregating one or more current purchase order items from at least one merchandiser within a local area;
bundling said aggregation of items with at least one item received from beyond said local area; and
retaining said items at an errand center storefront for retrieval by said consumer.

235. The method of claim 234 wherein said aggregating is performed by a local courier.

236. The method of claim 234 wherein said errand center storefront is a kiosk.

237. The method of claim 234 wherein a subscription data structure automatically enters on recurrent purchase orders items designated by the consumer for periodic delivery at periods designated by the consumer, without any further action being necessary by the consumer after the consumer designates the item and delivery period for the subscription item..

238. A consumer items delivery system comprising:
a scanner for entering into a current purchase order at least one item by scanning a unique product code identifying the item;
a courier for aggregating the items on the current purchase order from merchants in a local area;
a depot for bundling said aggregation of items with at least one item received from beyond said local area; and
an errand center storefront for retaining said items for retrieval by said consumer.

239. The system of claim 238 wherein a subscription data structure automatically enters on recurrent purchase orders items designated by the consumer for periodic delivery at periods designated by the consumer, without any further action being necessary by the consumer after the consumer designates the item and delivery period for the subscription item.

240. The system of claim 238 wherein said errand center storefront is a Kiosk.

241. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
selecting at least one current purchase order item from an Internet web page;
aggregating one or more items on the current purchase order from at least one merchandiser within a local area;
bundling said aggregation of items with at least one item received from beyond said local area; and
delivering said bundle of received and aggregated items to said consumer.

242. The method of claim 241 wherein said selecting is from the Internet web page of at least one merchant.

243. The method of claim 241 wherein said aggregating and said delivering are performed by a local courier.

244. The method of claim 241 wherein said delivering is to a kiosk.

245. The method of claim 241 wherein a subscription data structure automatically enters on recurrent purchase orders items designated by the consumer for periodic delivery at periods designated by the consumer, without any further action being necessary by the consumer after the consumer designates the item and delivery period for the subscription item.

246. A consumer item delivery system comprising:
a data structure storing information identifying at least one item designated by the consumer as a preferred item;
a record of items selected by the consumer as a current purchase order, said record including at least one preferred item;
an interactive display for selecting at least of one of the items stored on said consumer memory by said consumer from an Internet web page;
a courier for aggregating the items on the current purchase order from merchants in a local area;
a depot for bundling said aggregation of items with at least one item received from beyond the local area; and
delivering the bundle of received and aggregated items to said consumer.

247. The system of claim 246 wherein a subscription data structure automatically enters on recurrent purchase orders items designated by the consumer for periodic delivery at periods designated by the consumer, without any further action being necessary by the consumer after the consumer designates the item and delivery period for the subscription item.

248. The system of claim 246 wherein the selections from said interactive display are from the Internet web page of at least one merchant.

249. A method of delivering consumer items comprising:
recording a current purchase order of a consumer;
scanning a unique product code of at least one item to record data identifying the item in the current purchase order;
selecting at least one item for the current purchase order from an Internet web page;
aggregating one or more current purchase order items from at least one merchandiser within a local area;
bundling said aggregation of items with at least one item received from beyond said local area; and
delivering said bundle of received and aggregated items to said consumer.

250. The method of claim 249 wherein said selecting is from the Internet web page of at least one merchant.

251. The method of claim 249 wherein said aggregating and said delivering are performed by a local courier.

252. The method of claim 249 wherein said delivering is to a kiosk.

253. The method of claim 249 wherein a subscription data structure automatically enters on recurrent purchase orders items designated by the consumer for periodic delivery at periods designated by the consumer, without any further action being necessary by the consumer after the consumer designates the item and delivery period for the subscription item.

254. A consumer items delivery system comprising:
a scanner for entering into a current purchase order data identifying at least one item by scanning a unique product code for the item;
an interactive selection display for selecting at least one item from an Internet web page;
a courier for aggregating consumer selections from at least one merchant in a local area;
a depot for bundling said aggregation of items with at least one item received from beyond the local area; and
a courier for delivering said bundle of received and aggregated items to said consumer.

255. The system of claim 254 wherein said selecting is from the Internet web page of at least one merchant.

256. The system of claim 254 wherein a subscription data structure automatically enters on recurrent purchase orders items designated by the consumer for periodic delivery at periods designated by the consumer, without any further action being necessary by the consumer after the consumer designates the item and delivery period for the subscription item.

257. The system of claim 254 wherein said errand center storefront is a Kiosk.

258. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
aggregating one or more items on the current purchase order from at least one merchandiser within a local area;
bundling said aggregation of items with at least one item received from beyond said local area; and
delivering said bundle of received and aggregated items to said consumer.

259. The method of claim 258 wherein said aggregating and said delivering are performed by a local courier.

260. The method of claim 258 wherein said delivering is to a kiosk.

261. The method of claim 258 wherein a subscription data structure automatically enters on recurrent purchase orders items designated by the consumer for periodic delivery at periods designated by the consumer, without any further action being necessary by the consumer after the consumer designates the item and delivery period for the subscription item.

262. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
a courier for aggregating items on the current purchase order from at least one merchant in a local area;
a depot for bundling said aggregation of items with at least one item received from beyond the local area; and
a courier for delivering said bundle of received and aggregated items to said consumer.

263. The system of claim 262 wherein a subscription data structure automatically enters on recurrent purchase orders items designated by the consumer for periodic delivery at periods designated by the consumer, without any further action being necessary by the consumer after the consumer designates the item and delivery period for the subscription item.

264. The system of claim 262 wherein said delivering is to a kiosk.

265. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
selecting at least one item for the current purchase order from an Internet web page;
aggregating one or more items on the current purchase order from at least one merchandiser; and
retaining said items at an errand center storefront for retrieval by the consumer.

266. The method of claim 265 wherein said aggregating is performed by a local courier.

267. The method of claim 265 wherein said errand center storefront is a kiosk.

268. The method of claim 265 wherein a subscription data structure automatically enters on recurrent purchase orders items designated by the consumer for periodic delivery at periods designated by the consumer, without any further action being necessary by the consumer after the consumer designates the item and delivery period for the subscription item.

269. The method of claim 265 wherein said selecting is from the Internet web page of at least one merchant.

270. A consumer items delivery system comprising:
a data structure storing information identifying at least one item designated by the consumer as a preferred item;
a record of items selected by the consumer as a current purchase order, said record including at least one preferred item;
an interactive selection display for selecting at least one item for the current purchase order from an Internet web page;
a courier for aggregating said consumer selections;
an errand center storefront for retaining said items for retrieval by the consumer.

271. The system of claim 270 wherein a subscription data structure automatically enters on recurrent purchase orders items designated by the consumer for periodic delivery at periods designated by the consumer, without any further action being necessary by the consumer after the consumer designates the item and delivery period for the subscription item.

272. The system of claim 270 wherein said errand center storefront is a Kiosk.

273. The system of claim 270 wherein the selections from said interactive display are from the Internet web page of at least one merchant.

274. A method of delivering consumer items comprising:
recording a current purchase order of a consumer;
scanning a unique product code of at least one item to record data identifying the item in the current purchase order;
selecting at least one item for the current purchase order from an Internet web page;
aggregating one or more current purchase order items from at least one merchandiser; and
retaining the items at an errand center storefront for retrieval by said consumer.

275. The method of claim 274 wherein said selecting is from the Internet web page of at least one merchant.

276. The method of claim 274 wherein said aggregating is performed by a local courier.

277. The method of claim 274 wherein said errand center storefront is a kiosk.

278. The method of claim 274 wherein a subscription data structure automatically enters on recurrent purchase orders items designated by the consumer for periodic delivery at periods designated by the consumer, without any further action being necessary by the consumer after the consumer designates the item and delivery period for the subscription item.

279. A consumer items delivery system comprising:
a scanner for entering into a current purchase order data identifying at least one item by scanning a unique product code for the item;
an interactive selection display for selecting at least one item from an Internet web page;
a courier for aggregating items from the current purchase order; and
an errand center storefront for retaining said items for retrieval by said consumer.

280. The system of claim 279 wherein a subscription data structure automatically enters on recurrent purchase orders items designated by the consumer for periodic delivery at periods designated by the consumer, without any further action being necessary by the consumer after the consumer designates the item and delivery period for the subscription item.

281. The system of claim 279 wherein said errand center storefront is a Kiosk.

282. The system of claim 279 wherein the selections from said interactive display are from the Internet web page of at least one merchant.

283. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
aggregating one or more items on the current purchase order from at least one merchandiser; and
retaining said items at an errand center storefront for retrieval by said consumer.

284. The method of claim 283 wherein said aggregating is performed by a local courier.

285. The method of claim 283 wherein said errand center storefront is a kiosk.

286. The method of claim 283 wherein a subscription data structure automatically enters on recurrent purchase orders items designated by the consumer for periodic delivery at periods designated by the consumer, without any further action being necessary by the consumer after the consumer designates the item and delivery period for the subscription item.

287. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
a courier for aggregating items on the current purchase order from at least one merchant; and
an errand center storefront for retaining said items for retrieval by said consumer.

288. The system of claim 287 wherein a subscription data structure automatically enters on recurrent purchase orders items designated by the consumer for periodic delivery at periods designated by the consumer, without any further action being necessary by the consumer after the consumer designates the item and delivery period for the subscription item.

289. The system of claim 287 wherein said errand center storefront is a Kiosk.

290. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
aggregating one or more items on the current purchase order from at least one merchandiser within a local area;
selecting at least one item from an Internet web page;
aggregating said consumer selections; and
delivering said bundle of received and aggregated items to said consumer.

291. The method of claim 290 wherein said selecting is from the Internet web page of at least one merchant.

292. The method of claim 290 wherein said aggregating and said delivering are performed by a local courier.

293. The method of claim 290 wherein said delivering is to a kiosk.

294. The method of claim 290 wherein a subscription data structure automatically enters on recurrent purchase orders items designated by the consumer for periodic delivery at periods designated by the consumer, without any further action being necessary by the consumer after the consumer designates the item and delivery period for the subscription item.

295. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
a courier for aggregating items on the current purchase order from at least one merchant;
an interactive selection display for selecting at least one item for the current purchase order from an Internet web page;
a courier for delivering said consumer order.

296. The system of claim 295 wherein a subscription data structure automatically enters on recurrent purchase orders items designated by the consumer for periodic delivery at periods designated by the consumer, without any further action being necessary by the consumer after the consumer designates the item and delivery period for the subscription item.

297. The system of claim 295 wherein the selections from said interactive display are from the Internet web page of at least one merchant.

298. The system of claim 295 wherein said delivering is to a kiosk.

299. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
selecting at least one current purchase order item from an Internet web page;
bundling from merchants within a local area items with at least one item received from beyond the local area; and
retaining said items at an errand center storefront for retrieval by said consumer.

300. The method of claim 299 wherein said selecting is from the Internet web page of at least one merchant.

301. The method of claim 299 wherein said bundling is performed by a local courier.

302. The method of claim 299 wherein said errand center storefront is a kiosk.

303. The method of claim 299 wherein a subscription data structure automatically enters on recurrent purchase orders items designated by the consumer for periodic delivery at periods designated by the consumer, without any further action being necessary by the consumer after the consumer designates the item and delivery period for the subscription item.

304. A consumer items delivery system comprising:
a data structure storing information identifying at least one item designated by the consumer as a preferred item;
a record of items selected by the consumer as a current purchase order, said record including at least one preferred item;
an interactive display for selecting at least of one of the items stored on said consumer memory by said consumer from an Internet web page;
a depot for bundling items from merchants within a local area with at least one item received from beyond the local area; and
an errand center storefront for retaining said items for retrieval by said consumer.

305. The system of claim 304 wherein a subscription data structure automatically enters on recurrent purchase orders items designated by the consumer for periodic delivery at periods designated by the consumer, without any further action being necessary by the consumer after the consumer designates the item and delivery period for the subscription item.

306. The system of claim 304 wherein said errand center storefront is a Kiosk.

307. The system of claim 304 wherein the selections from said interactive display are from the Internet web page of at least one merchant.

308. A method of delivering consumer items comprising:
recording a current purchase order of a consumer;
scanning a unique product code of at least one item to record data identifying the item in the current purchase order;
selecting at least one item for the current purchase order from an Internet web page;
bundling items from merchants within a local area with at least one item received from beyond the local area; and
retaining the items at an errand center storefront for retrieval by said consumer.

309. The method of claim 308 wherein said selecting is from the Internet web page of at least one merchant.

310. The method of claim 308 wherein said bundling is performed by a local courier.

311. The method of claim 308 wherein said errand center storefront is a kiosk.

312. The method of claim 308 wherein a subscription data structure automatically enters on recurrent purchase orders items designated by the consumer for periodic delivery at periods designated by the consumer, without any further action being necessary by the consumer after the consumer designates the item and delivery period for the subscription item.

313. A consumer items delivery system comprising:
a scanner for entering into a current purchase order data identifying at least one item by scanning a unique product code for the item;
an interactive selection display for selecting at least one item from an Internet web page;
a depot for bundling items from merchants within a local area with at least one item received from beyond the local area; and
an errand center storefront for retaining said items for retrieval by said consumer.

314. The method of claim 313 wherein a subscription data structure automatically enters on recurrent purchase orders items designated by the consumer for periodic delivery at periods designated by the consumer, without any further action being necessary by the consumer after the consumer designates the item and delivery period for the subscription item.

315. The system of claim 313 wherein said errand center storefront is a Kiosk.

316. The system of claim 313 wherein the selections from said interactive display are from the Internet web page of at least one merchant.

317. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
bundling one or more items from the current purchase order from at least one merchandiser within a local area, with at least one item received from beyond the local area; and
retaining said items at an errand center storefront for retrieval by said consumer.

318. The method of claim 317 wherein said bundling is performed by a local courier.

319. The method of claim 317 wherein said errand center storefront is a kiosk.

320. The method of claim 317 wherein a subscription data structure automatically enters on recurrent purchase orders items designated by the consumer for periodic delivery at periods designated by the consumer, without any further action being necessary by the consumer after the consumer designates the item and delivery period for the subscription item.

321. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
a depot for bundling items from within a local area with at least one item received from beyond said local area; and
an errand center storefront for retaining said items for retrieval by said consumer.

322. The system of claim 321 wherein a subscription data structure automatically enters on recurrent purchase orders items designated by the consumer for periodic delivery at periods designated by the consumer, without any further action being necessary by the consumer after the consumer designates the item and delivery period for the subscription item.

323. The system of claim 321 wherein said errand center storefront is a Kiosk.

324. The method of claim 321 wherein said bundling is performed by a local courier.

325. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
selecting at least one item for the current purchase order from an Internet web page;
bundling items from merchants in a local area with at least one item received from beyond said local area; and
delivering said bundle of received and aggregated items to said consumer.

326. The method of claim 325 wherein said bundling and said delivering are performed by a local courier.

327. The method of claim 325 wherein said delivering is to a kiosk.

328. The method of claim 325 wherein a subscription data structure automatically enters on recurrent purchase orders items designated by the consumer for periodic delivery at periods designated by the consumer, without any further action being necessary by the consumer after the consumer designates the item and delivery period for the subscription item.

329. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
an interactive selection display for selecting at least one item for the current purchase order from an Internet web page;
a depot for bundling said items from merchants in a local area with at least one item received from beyond said local area.

330. The system of claim 329 wherein a subscription data structure automatically enters on recurrent purchase orders items designated by the consumer for periodic delivery at periods designated by the consumer, without any further action being necessary by the consumer after the consumer designates the item and delivery period for the subscription item.

331. The system of claim 329 wherein the selections from said interactive display are from the Internet web page of at least one merchant.

332. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
selecting at least one item for the current purchase order from an Internet web page;
retaining said items at an errand center storefront for retrieval by said consumer.

333. The method of claim 332 wherein said selecting is from the Internet web page of at least one merchant.

334. The method of claim 332wherein said errand center storefront is a kiosk.

335. The method of claim 332 wherein a subscription data structure automatically enters on recurrent purchase orders items designated by the consumer for periodic delivery at periods designated by the consumer, without any further action being necessary by the consumer after the consumer designates the item and delivery period for the subscription item.

336. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
an interactive selection display for selecting at least one item for the current purchase order from an Internet web page; and
an errand center storefront for retaining said items for retrieval by said consumer.

337. The system of claim 336 wherein a subscription data structure automatically enters on recurrent purchase orders items designated by the consumer for periodic delivery at periods designated by the consumer, without any further action being necessary by the consumer after the consumer designates the item and delivery period for the subscription item.

338. The system of claim 336 wherein said errand center storefront is a Kiosk.

339. The system of claim 336 wherein the selections from said interactive display are from the Internet web page of at least one merchant.

340. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
selecting at least one item for the current purchase order from an Internet web page;
aggregating one or more items on the current purchase order from at least one merchandiser within a local area;
bundling said aggregation of items with at least one item received from beyond said local area; and
retaining said items at an errand center storefront for retrieval by said consumer.

341. The method of claim 340 wherein said selecting is from the Internet web page of at least one merchant.

342. The method of claim 340 wherein said aggregating is performed by a local courier.

343. The method of claim 340 wherein said errand center storefront is a kiosk.

344. The method of claim 340 wherein a subscription data structure automatically enters on recurrent purchase orders items designated by the consumer for periodic delivery at periods designated by the consumer, without any further action being necessary by the consumer after the consumer designates the item and delivery period for the subscription item.

345. A consumer items delivery system comprising:
a data structure storing information identifying at least one item designated by the consumer as a preferred item;
a record of items selected by the consumer as a current purchase order, said record including at least one preferred item;
an interactive selection display for selecting at least one item for the current purchase order from an Internet web page; and
a courier for aggregating items on the current purchase order from at least one merchant;
a depot for bundling said aggregation of items with at least one item received from beyond a local area; and
an errand center storefront for retaining said items for retrieval by said consumer.

346. The system of claim 345 wherein a subscription data structure automatically enters on recurrent purchase orders items designated by the consumer for periodic delivery at periods designated by the consumer, without any further action being necessary by the consumer after the consumer designates the item and delivery period for the subscription item.

347. The system of claim 345 wherein said errand center storefront is a Kiosk.

348. The system of claim 345 wherein the selections from said interactive display are from the Internet web page of at least one merchant.

349. A method of delivering consumer items comprising:
recording a current purchase order of the consumer;
scanning a unique product code for entering onto the current purchase order data identifying at least one item;
selecting at least one item for the current purchase order from an Internet web page;
aggregating one or more items on the current purchase order from at least one merchandiser within a local area;
bundling said aggregation of items with at least one item received from beyond said local area; and
retaining said items at an errand center storefront for retrieval by said consumer.

350. The method of claim 349 wherein said selecting is from the Internet web page of at least one merchant.

351. The method of claim 349 wherein said aggregating and said delivering are performed by a local courier.

352. The method of claim 349 wherein said errand center storefront is a kiosk.

353. The method of claim 349 wherein a subscription data structure automatically enters on recurrent purchase orders items designated by the consumer for periodic delivery at periods designated by the consumer, without any further action being necessary by the consumer after the consumer designates the item and delivery period for the subscription item.

354. A consumer items delivery system comprising:
a scanner for entering into said consumer memory list at least one item by scanning a unique product code for the item;
a record of items selected by the consumer as a current purchase order;
an interactive selection display for selecting at least one item for the current purchase order from an Internet web page;
a courier for aggregating items on the current purchase order from at least one merchant;
a depot for bundling said aggregation of items with at least one item received from beyond a local area; and
an errand center storefront for retaining said items for retrieval by said consumer.

355. The system of claim 354 wherein a subscription data structure automatically enters on recurrent purchase orders items designated by the consumer for periodic delivery at periods designated by the consumer, without any further action being necessary by the consumer after the consumer designates the item and delivery period for the subscription item.

356. The system of claim 354 wherein said errand center storefront is a Kiosk.

357. The system of claim 354 wherein the selections from said interactive display are from the Internet web page of at least one merchant.

358. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
aggregating one or more items on the current purchase order from at least one merchandiser within a local area;
bundling said aggregation of items with at least one item received from beyond said local area; and
retaining said items at an errand center storefront for retrieval by said consumer.

359. The method of claim 358 wherein said aggregating and said delivering are performed by a local courier.

360. The method of claim 358 wherein said errand center storefront is a kiosk.

361. The method of claim 358 wherein a subscription data structure automatically enters on recurrent purchase orders items designated by the consumer for periodic delivery at periods designated by the consumer, without any further action being necessary by the consumer after the consumer designates the item and delivery period for the subscription item.

362. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
a courier for aggregating items on the current purchase order from at least one merchant;
a depot for bundling said aggregation of items with at least one item received from beyond a local area; and
an errand center storefront for retaining said items for retrieval by said consumer.

363. The system of claim 362 wherein said errand center storefront is a Kiosk.

364. The system of claim 362 wherein a subscription data structure automatically enters on recurrent purchase orders items designated by the consumer for periodic delivery at periods designated by the consumer, without any further action being necessary by the consumer after the consumer designates the item and delivery period for the subscription item.

365. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
selecting at least one item for the current purchase order from an Internet web page;
aggregating one or more items on the current purchase order from at least one merchandiser within a local area;
bundling said aggregation of items with at least one item received from beyond said local area; and
delivering said bundle of received and aggregated items to said consumer.

366. The method of claim 365 wherein said selecting is from the Internet web page of at least one merchant.

367. The method of claim 365 wherein said aggregating and said delivering is performed by a local courier.

368. The method of claim 365 wherein said delivering is to a kiosk.

369. The method of claim 365 wherein a subscription data structure automatically enters on recurrent purchase orders items designated by the consumer for periodic delivery at periods designated by the consumer, without any further action being necessary by the consumer after the consumer designates the item and delivery period for the subscription item.

370. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
an interactive selection display for selecting at least one item for the current purchase order from an Internet web page;
a courier for aggregating items on the current purchase order from at least one merchant;
a depot for bundling said aggregation of items with at least one item received from beyond a local area; and
a courier for delivering the current purchase order items to the consumer.

371. The system of claim 371 wherein the selections from said interactive display are from the Internet web page of at least one merchant.

372. The system of claim 371 wherein a subscription data structure automatically enters on recurrent purchase orders items designated by the consumer for periodic delivery at periods designated by the consumer, without any further action being necessary by the consumer after the consumer designates the item and delivery period for the subscription item.

373. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
selecting at least one item for the current purchase order from an Internet web page;
aggregating one or more items on the current purchase order from at least one merchandiser within a local area; and
retaining said items at an errand center storefront for retrieval by said consumer.

374. The method of claim 373 wherein said selecting is from the Internet web page of at least one merchant.

375. The method of claim 373 wherein said aggregating and said delivering are performed by a local courier.

376. The method of claim 373 wherein said errand center storefront is a kiosk.

377. The method of claim 373 wherein a subscription data structure automatically enters on recurrent purchase orders items designated by the consumer for periodic delivery at periods designated by the consumer, without any further action being necessary by the consumer after the consumer designates the item and delivery period for the subscription item.

378. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
an interactive selection display for selecting at least one item for the current purchase order from an Internet web page;
a courier for aggregating items on the current purchase order from at least one merchant; and
an errand center storefront for retaining said items for retrieval by said consumer.

379. The system of claim 378 wherein the selections from said interactive display are from the Internet web page of at least one merchant.

380. The system of claim 378 wherein said errand center storefront is a Kiosk.

381. The method of claim 378 wherein a subscription data structure automatically enters on recurrent purchase orders items designated by the consumer for periodic delivery at periods designated by the consumer, without any further action being necessary by the consumer after the consumer designates the item and delivery period for the subscription item.

382. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
selecting at least one item for the current purchase order from an Internet web page;
bundling items from merchants in a local area with at least one item received from beyond said local area; and
retaining said items at an errand center storefront for retrieval by said consumer.

383. The method of claim 382 wherein said selecting is from the Internet web page of at least one merchant.

384. The method of claim 382 wherein said aggregating and said delivering are performed by a local courier.

385. The method of claim 382 wherein said errand center storefront is a kiosk.

386. The method of claim 382 wherein a subscription data structure automatically enters on recurrent purchase orders items designated by the consumer for periodic delivery at periods designated by the consumer, without any further action being necessary by the consumer after the consumer designates the item and delivery period for the subscription item.

387. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
an interactive selection display for selecting at least one item for the current purchase order from an Internet web page;
a depot for bundling said aggregation of items with at least one item received from beyond a local area; and
an errand center storefront for retaining said items for retrieval by said consumer.

388. The system of claim 387 wherein the selections from said interactive display are from the Internet web page of at least one merchant.

389. The system of claim 387 wherein said errand center storefront is a Kiosk.

390. The system of claim 387 wherein a subscription data structure automatically enters on recurrent purchase orders items designated by the consumer for periodic delivery at periods designated by the consumer, without any further action being necessary by the consumer after the consumer designates the item and delivery period for the subscription item.

391. A method of delivering consumer items comprising:
storing data identifying at least one item designated by a consumer as preferred, said data being retained for a time beyond a delivery of a current purchase order;
recording a current purchase order of the consumer, the order including at least one item corresponding to said stored preferred item data;
scanning a unique product code for entering onto the current purchase order data identifying at least one item;
selecting at least one item for the current purchase order from an Internet web page;
aggregating one or more items on the current purchase order from at least one merchandiser within a local area;
bundling items from merchants in a local area with at least one item received from beyond the local area; and
retaining said items at an errand center storefront for retrieval by the consumer.

392. The method of claim 391 wherein said aggregating is performed by a local courier.

393. The method of claim 391 wherein said delivering is to a kiosk.

394. The method of claim 391 wherein a subscription data structure automatically enters on recurrent purchase orders items designated by the consumer for periodic delivery at periods designated by the consumer, without any further action being necessary by the consumer after the consumer designates the item and delivery period for the subscription item.

395. A consumer items delivery system comprising:
a data structure storing information identifying at least one item designated by the consumer as a preferred item;
a record of items selected by the consumer as a current purchase order, said record including at least one preferred item;
a scanner for entering into the current purchase order data identifying at least one item by scanning a unique product code for the item;
an interactive selection display for selecting at least one item for the current purchase order from an Internet web page;
a courier for aggregating items on the current purchase order from at least one merchant in a local area;
a depot for bundling said aggregation of items with at least one item received from beyond the local area; and
an errand center storefront for retaining said items for retrieval by said consumer.

396. The system of claim 395 wherein the selections from said interactive display are from the Internet web page of at least one merchant.

397. The system of claim 395 wherein said errand center storefront is a Kiosk.

398. The system of claim 395 wherein a subscription data structure automatically enters on recurrent purchase orders items designated by the consumer for periodic delivery at periods designated by the consumer, without any further action being necessary by the consumer after the consumer designates the item and delivery period for the subscription item.
